(19) United States
(12) Patent Application Publication
(10) Pub. No.: US 2011/0040215 A1
(43) Pub. Date: Feb. 17, 2011

(54) LEG MOVEMENT RAIL FOR THE REPETITIVE MOVEMENT OF THE KNEE AND HIP JOINT WITH ASSISTANCE FUNCTION FOR ACTIVE USE

(75) Inventor: Gerhard Knoll, Umkirch (DE)

Correspondence Address: BACON & THOMAS, PLLC, 625 SLATERS LANE, FOURTH FLOOR, ALEXANDRIA, VA, 22314-1176, US

(73) Assignee: Medireha GmbH Produkte fur die medizinische Rehabilitation, Umkirch (DE)

(21) Appl. No.: 12/736,652

(22) PCT Filed: Apr. 30, 2009
(86) PCT No.: PCT/EP2009/003126

§ 371 Date: Oct. 27, 2010

(30) Foreign Application Priority Data
May 5, 2008 (DE) 10 2008 023 573.3

(51) Int. Cl. A61H 1/02

(52) U.S. Cl. 601/34; 482/4

(57) ABSTRACT

A leg movement rail (10) for the repetitive movement of the knee and hip joint comprises a base (20), a motor and gearbox unit (204), and a motor control unit (205) on the base (20), a mounting (12, 13) on the femoral side that is fastened at one end thereof by means of a rotary joint (31) to the base, a mounting (14, 15) on the lower thigh that is fastened on the base (20) by means of a joint displaceably arranged along the base (20), and a joint mechanism (27) connecting the other end of the mounting (14, 15) on the lower thigh and the mounting (12, 13) on the femoral side. In order to be able to incrementally shift the movement exercises from a passive into an active form of therapy as a function of the gradual restoration of the patient's mobility, in addition to an adjustable continuously passive movement of the leg movement rail (10) by the motor and gearbox unit (204), according to the invention an active mobilization of the leg movement rail (10) by the patient, influencing said passive movement, can be brought about in that the pressure and/or tensile forces applied by the patient can be determined by sensors (206) and/or a measurement of the current/rotational speed. The measurement values thereof are fed to the motor control unit (205) and are forwarded as controlled variables for the motor and gearbox unit (204).

The present invention relates to a leg movement rail for the repetitive movement of the knee and hip joint in accordance with the preamble of Claim 1.

A leg movement rail that is known from EP 0 676 944 B1 for the repetitive movement of the knee and hip joint achieves continuously passive movement with no force being exerted during the movement between the leg movement rail and the leg being treated. Through movements of this type in hip and knee joints that have been recently operated on, the healing process is stimulated and shortened, and the restoration of traumatized joints is speeded up. In this context, as mentioned, the leg of the patient is moved only by the continuously passive movement rail.

Leg movement rails are also known that can be used as active orthoses and can allow the patient to continue to improve the healing process through the application of stress. In a leg movement rail of this type, which is known from DE 35 21 470 A1, a foot support can be moved in the longitudinal direction to encourage active mobilization, said movement being brought about through the action of springs in the pressure and/or tension direction. In this context, the patients must therefore work against this predetermined spring load, which results in speeding the recovery of atrophied muscles, for example. In the case of this familiar leg movement rail, a pressure cell is provided in the foot part, said cell emitting an optical signal as a function of the patient activity, on the basis of which the patient can check his or her progress. This has no effect on the continuously passive movement sequence of the leg movement rail.

The objective of the present invention is therefore to combine what have hitherto been separate therapy methods in one leg movement rail in such a way that, with the gradual restoration of patient mobility, the exercises can incrementally shift from a purely passive, through a combined passive/active, to a purely active form of therapy, in which the patient can manually cause the motor support to be more or less reduced.

To achieve this objective, the features indicated in Claim 1 are provided in a leg movement rail of the aforementioned type.

As a result of the inventive measures, as a function of the patient activity based on the pressure and/or tensile forces exerted by the patient, the leg movement rail can be shifted incrementally from an exclusively passive to an at least partially active movement activity, i.e., one produced by the patient him or herself. As a result, the same leg movement rail is capable of requiring an application of force from the patient and determining the actual application of force that is still needed from the apparatus. The measuring system that is used in this process in the form of sensors and/or a current/rotational speed measurement can measure forces in the directions of both bending and stretching.

Advantageous embodiments with respect to the influence of patient activities on shifting the leg movement rail from passive via a combined passive/active to active movement, or vice versa, can be seen from the features of Claim 2 and/or 3. In this context, the motor and transmission unit can allow force to be applied as support for the patient's movement in preset percentage values between 100% and 0%.

Advantageous embodiments of the motor control unit can be seen from the features of at least one of Claims 4 to 7.

If sensors that measure the pressure and/or tensile forces that are applied by the patient are used in the measuring system, said sensors may be arranged at various locations or areas on the leg movement rail. In accordance with the features according to Claims 8 and 9, 10 and 11, or 12 and 13, the sensors may be arranged either between the threaded spindle and the sliding carriage, between the threaded spindle and a bearing block that accommodates said threaded spindle, or between the threaded spindle and the foot part of the leg movement rail, either individually or in combination.

Further details of the invention may be seen from the following description, in which the invention is explained and described in greater detail on the basis of the exemplary embodiments that are depicted in the drawing. In the drawing:

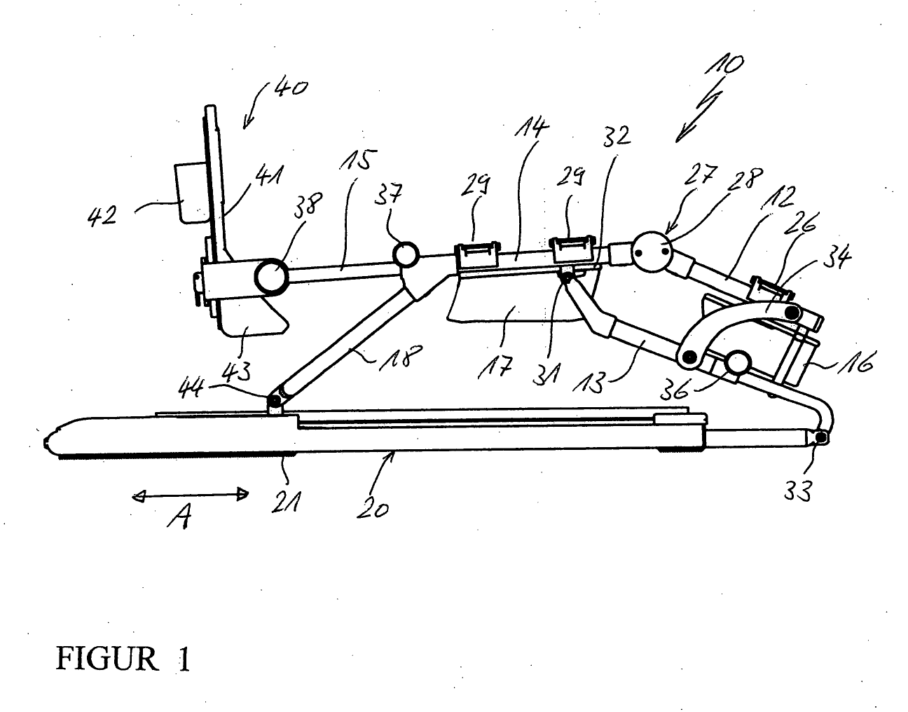

FIG. 1 in a schematic side view, depicts a leg movement rail for the repetitive movement of the knee and hip joint in accordance with one preferred exemplary embodiment of the present invention,

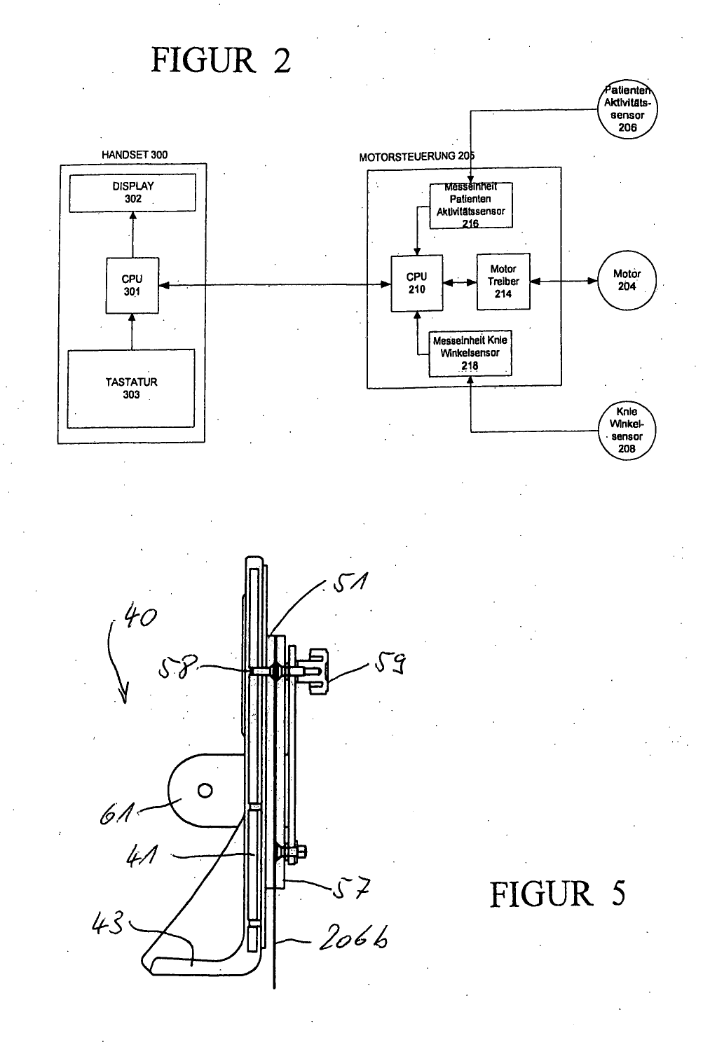

FIG. 2 depicts a block diagram to represent the functioning of the leg movement rail in accordance with FIG. 1,

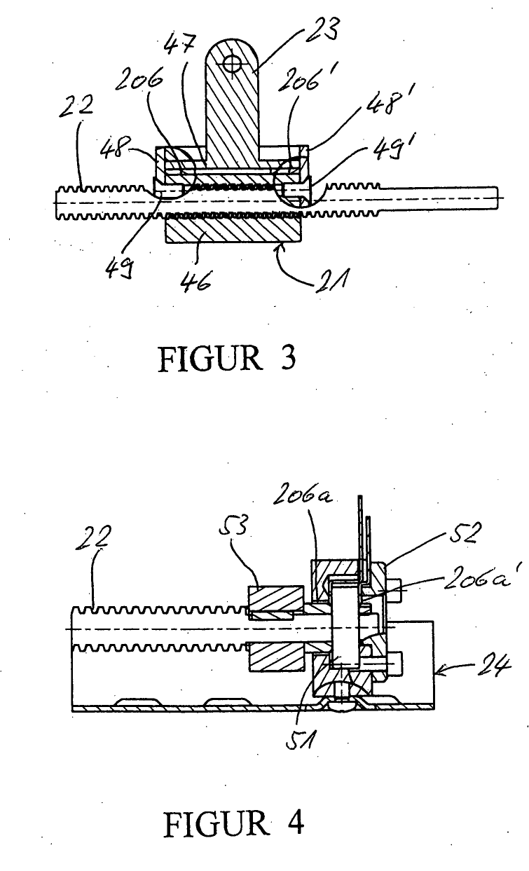

FIG. 3 depicts the design and position of pressure sensors for patient activities in accordance with a first embodiment,

FIG. 4 depicts the design and position of pressure sensors for patient activities in accordance with a second embodiment,

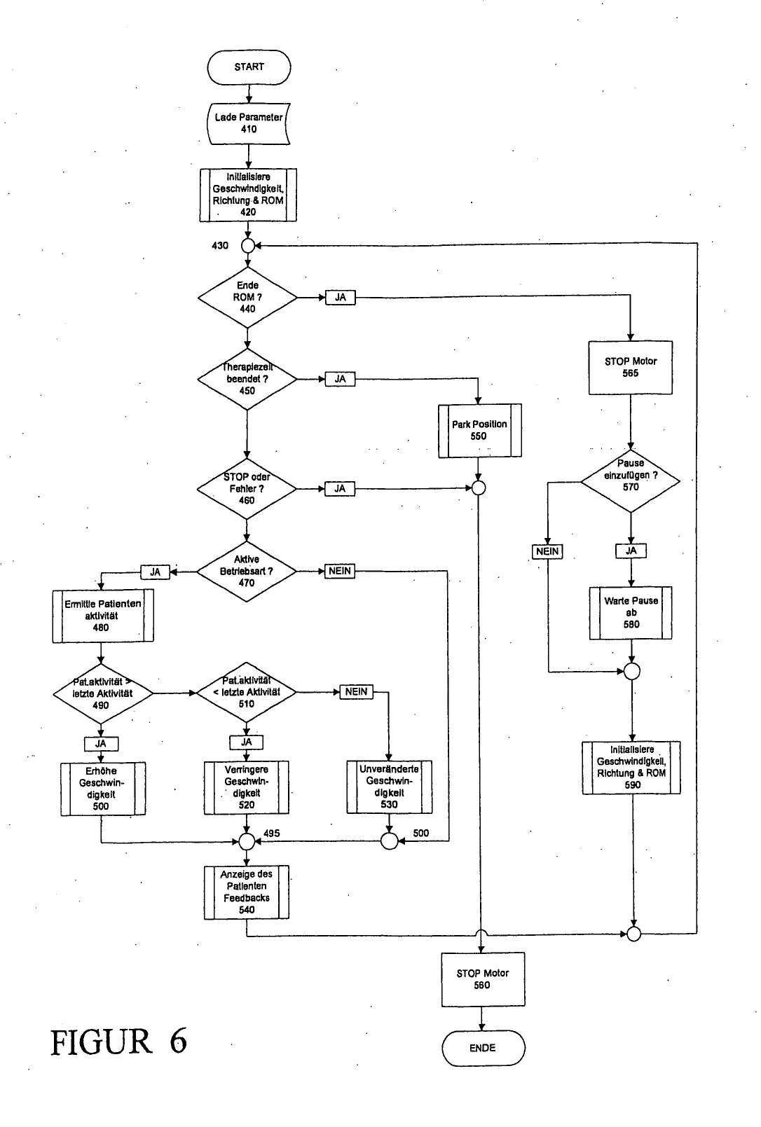

FIG. 5 depicts the design and position of pressure sensors for patient activities in accordance with a third embodiment,

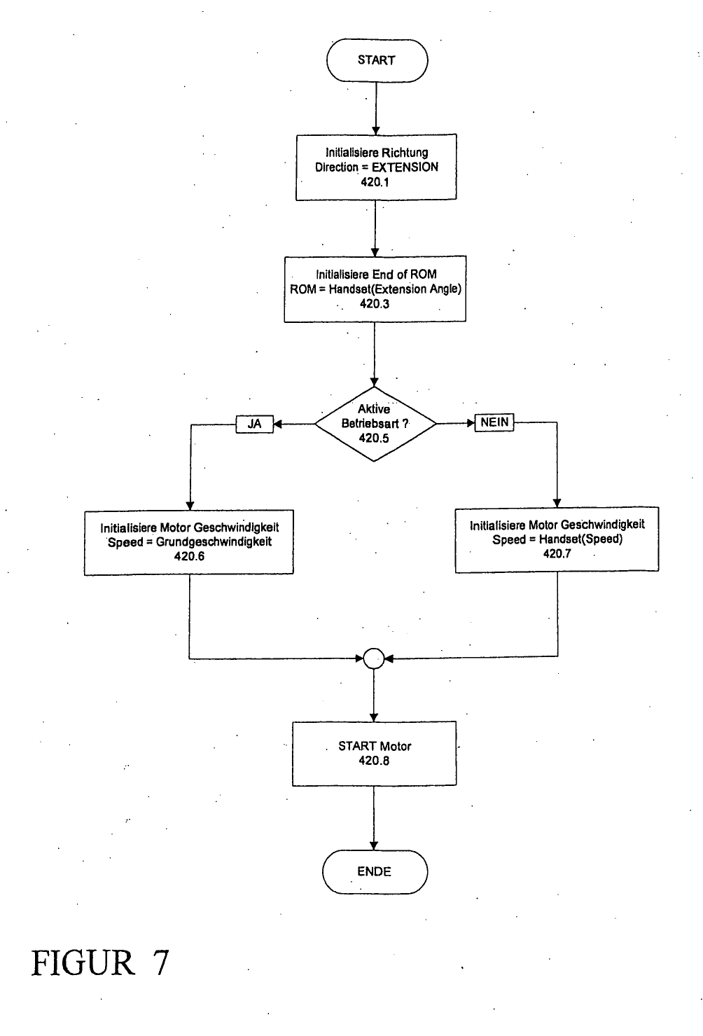

FIG. 6 depicts a sequence program of the leg movement rail in accordance with FIG. 1,

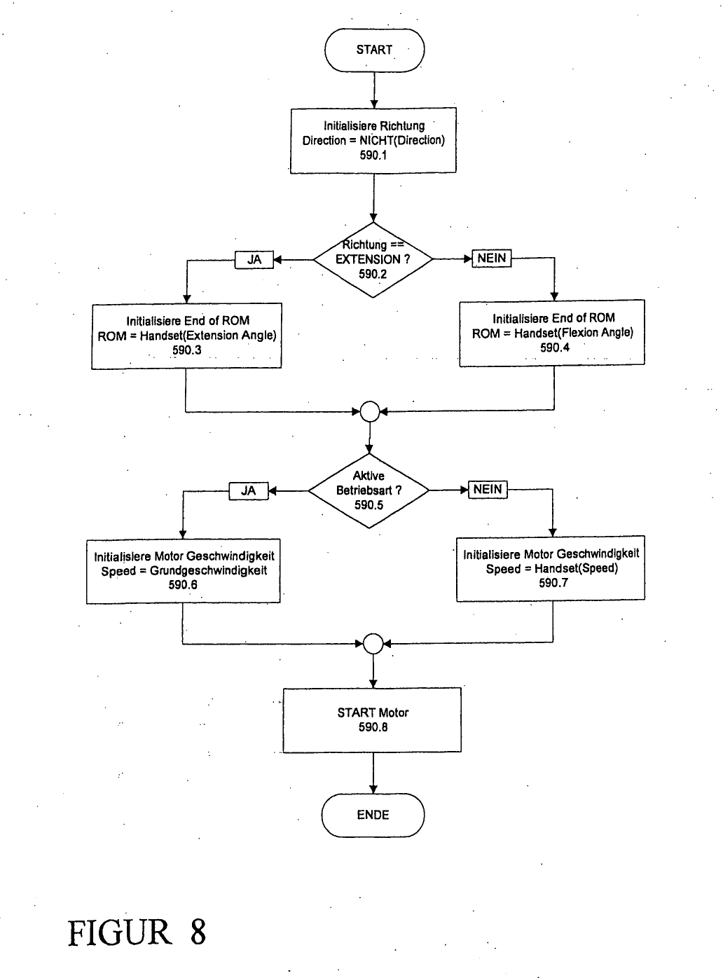

FIGS. 7 and 8 depict a sequence subprogram for the sequence program in accordance with FIG. 6.

Leg movement rail 10 as depicted in FIG. 1 in accordance with one preferred exemplary embodiment is designed for a patient, for example after an operation on the hip joint and/or knee joint or a traumatized joint, in order to speed the healing process of said joint or joints, so as to facilitate both the continuously passive leg movement as well as the active, motor-supported leg movement of the patient. Leg movement rail 10 is designed so that the movement between the complete stretching and bending of the joint or joints is carried out in an anatomically correct manner. In addition, leg movement rail 10 may be adapted for various patient sizes with respect to the length of the lower leg or thigh, the slope of the foot plate, and the height of the ankle.

Leg movement rail 10 has an orthosis 11 that is made up of a multiplicity of supports that are flexibly connected to each other in the form of pairs of parallel rods 12 to 15, between which, in a manner that is not depicted in detail, contact means 16, 17 are supported, for example in the form of shell-like pieces for the various parts of a patient's leg. Orthosis 11 is connected via a connecting element in the form of a connecting pair of rods 18 to a gliding carriage 21 on a base 20, which is formed by a corresponding framework of parallel rods or by a plate. As will be indicated below, sliding carriage 21 can be moved back and forth by a motor along base 20 in accordance with double arrow A.

Pair of rods 12 acting via contact means 16 supports the thigh of the patient and is provided with at least one securing strap 26 for the thigh. Pair of rods 12 for the thigh is movably connected to pair of rods 14 for the lower leg of the patient via a joint mechanism 27, which is provided with an angle sensor 28, as depicted only schematically. Pair of rods 14 for the lower leg in the area of contact means 17 is provided, for example, with two securing straps 29 that are arranged at a distance apart. A further pair of rods 13 for the thigh, which facilitates setting both the angular position and the length of pair of rods 12 for the thigh, is at one end longitudinally movable via a joint 31 along a rail 32 on the lower side of pair of rods 14 for the lower leg, and at the other end is flexibly connected via a hinge 33 to the assigned end of base 20. In addition, a further pair of rods 13 in area 36 may be adjusted in length in telescopic fashion, thus making it possible to take into account the length of the thigh of the patient. Sickle-shaped arms 34 are provided in hinge fashion between pairs of rods 12 and 13 for the thigh.

Extending pairs of rods 15 in area 37 are connected to pairs of rods 14 for the lower leg in such a way that the length is adjustable, said extending pairs of rods 15 being connected at their free end facing away from pairs of rods 14 via a joint 38 to a shoe-shaped foot support 40, which is provided with a foot sole plate 41, on which securing straps 42 are provided for the patient's foot. Foot sole plate 41 with its heel support 43 can be adjusted in its slope with respect to extending pairs of rods 15, and it can also be adjusted with respect to the ankle height of the patient.

A connecting pair of rods 18, at one end, is joined to connection 39 between pair of rods 14 for the lower leg and extending pair of rods 15, and at the other end, is joined via a joint 44 to glide carriage 21. With the back-and-forth motion (double arrow A) of sliding carriage 21, pairs of rods 14 for the lower leg having extending pairs of rods 15 are moved back and forth, along with, via knee joint mechanism 27 having angle sensor 28, pairs of rods 12 and 13 for the thigh.

Base 20, which is not depicted in FIG. 1 but is depicted in block fashion in FIG. 2, supports a motor and transmission unit 204 and a motor control unit 205 for the motor, which is preferably electrically driven. Motor and transmission unit 204 is connected in a rotationally fixed manner to a threaded spindle 22, which preferably has a trapezoidal thread (FIG. 3), said threaded spindle 22 moving a carrier 23 of sliding carriage 21 back and forth. Threaded spindle 22, at one end, is fixedly supported in the transmission unit and, at the other end, is supported in an end bearing block 24 (FIG. 4). In accordance with one undepicted embodiment, sliding carriage 21 is moved back and forth, i.e., in translatory fashion, not via a threaded rod drive but rather via a hydraulic or pneumatic cylinder or via an electromechanical linear drive (linear motor).

By means of motor and transmission unit 204, connecting pair of rods 18, which are supported in an articulated manner on base 20, can be given a back-and-forth motion via sliding carriage 21, thus activating joint mechanism 27, which is provided with angle sensor 28, and an anatomical path of the knee joint about the rotational axis of the hip joint is imitated. In the process, knee angle sensor 218 of absolute angle sensor 28 detects the current bending angle of the patient's knee. Motor control unit 205 takes over the electronic control of drive motor 205 and has a preferably wired connection to a remote control unit (handset) 300, knee angle sensor 218, and a measuring system that is arranged in sliding carriage 21, for example. Remote control unit 300 makes parameterizing and operating-mode selection possible, in other words whether the patient's leg is to execute a purely passive motion or an active motion that is supported by a passive motion. Remote control unit 300 also takes over the sequence control and functions as the control display for the device. A keypad 303 carries out the parameterizing and the starting and stopping of both movement rails 10. A display 302 shows the operating mode, the programmed parameters, and the current measured values.

The principle of operation of the continuous, purely passive operating mode is familiar and can be seen from EP 0 676 944 B1, for example. In this case, the motor and transmission unit applies a force that moves the patient's leg within a preset angular range between extending and bending at a predetermined velocity.

In the active operating mode, in contrast to passive motion, the patient is required to make his or her own exertion. In this context, electromotive drive 204 only takes over the application of force as a support to the motion, corresponding to the preset percentage value between 100% and 0% of motor support. To set leg movement rail 10 in motion and to maintain said motion, the patient must exert the minimum required force. Measuring system 216, which is located on sliding carriage 21 and is connected to an activity sensor 206, measures this force, which is accordingly supplied to the drive as a control variable via motor control unit 205. If the patient reduces his or her exertion, this results in a reduced motor output, and the movement slows and can even stop. If the exertion of force is increased, a corresponding increase in the velocity occurs. By means of displays that are attached to display 302 on remote control unit 300, or alternatively that are attached on base 20, the patient can perceive his or her success at “cooperation” as acoustic or visual feedback, and he or she can take the appropriate corrective measures with respect to exerting more or less force.

FIG. 2 shows a typical realization of leg movement rail 10 in the form of a block diagram. Leg movement rail 10, as mentioned, includes remote control unit 300 as well as a motor control unit 205, which has an attached drive unit 204 that preferably includes an electromotor with a transmission attachment, a unit having a knee angle sensor 208 for the current measuring unit 218, and the unit that includes activity sensor 206 for the pressure and tensile forces that the patient exerts on leg movement rail 10. As indicated below (FIGS. 3 to 5), pressure and tension sensors 206 can be designed and arranged in various ways and in various locations on leg movement rail 10.

Remote control unit 300 is essentially made up of a microprocessor (CPU) 301, a display 302 for issuing and presenting information, and a keypad 303 for inputting. Using keypad 303 the user can program remote control unit 300 so that the sequence program that is necessary for controlling leg movement rail 10 can be started or stopped. Via an undepicted communications interface, remote control unit 300 is linked to a microprocessor 210 (CPU) of motor control unit 205. Via this interface, commands as well as status and error information is exchanged.

Via one driver unit 214, CPU 210 of motor control unit 205 can control drive unit 204, i.e., the electromotor. The velocity is regulated and the rotational direction is set via driver unit 214. Through knee angle sensor measuring unit 218, CPU 210 can determine the current angular position as supplied by knee angle sensor 208. A positioning command from remote control unit 300 independently monitors CPU 210 and halts motor 204 at the programmed destination position by specifying the angle that is set in knee angle sensor 208.

In the active operating mode, patient activity sensor measuring unit 216 ascertains the pressure and tensile forces exerted by the patient through patient activity sensor or sensors 206, and said forces are transmitted to remote control unit 300 for further processing. Said remote control unit increases or decreases the velocity of drive unit 204 as a function of patient activity.

As already mentioned, sensor 206, which measures the pressure or tensile forces, can be provided at various selected locations on leg movement rail 10. In other words, for the decrease of the pressure and tensile forces exerted in patient activity in the active operation mode, multiple appropriate locations or positions can be employed, as is discussed below on the basis of FIGS. 3 to 5. Sensors 206 may be formed, for example, by piezo elements or strain gauge strips.

According to FIG. 3, pressure and tension sensors 206, 206′ are attached beneath carrier 23 of sliding carriage 21. In this context, the tensile and pressure forces that the patient exerts on leg movement rail 10 are transmitted vertically via carrier 23 to sensors 206, 206′. From the information on the direction of motion of leg movement rail 10 and from the measured forces from sensors 206, 206′, the pressure and tensile forces created by the patient may be monitored separately and may be further processed by the control program.

In the exemplary embodiment in FIG. 3, carrier 23 of sliding carriage 21 is provided with a trapezoidal interior thread and is configured in accordance with the exterior thread of threaded spindle 22, whereby between this interior thread sleeve 46 and a carrier connection 47 at the respective axial ends, a sensor 206, 206′ is arranged in the form of a flat sensor. Flat sensors 206, 206′ are covered at both ends by a side plate 48, 48′, which is attached on interior thread sleeve 46 by a bolt 49, 49′.

FIG. 4 shows an alternative measurable absorption of the tensile and pressure forces in the area of end bearing block 24. The tensile and pressure forces that have been caused by the patient and have been transmitted via sliding carriage 21 and threaded spindle 22 can be picked up in the area of a ball bearing 51 for threaded spindle 22. Via sensors 206a, 206a′, which are attached on both sides, the tensile and pressure forces that arise can be measured and further processed by the control program. Pressure sensors 206a, 206a′ are configured as ring sensors, which are arranged in the axial or radial position on both sides of ball bearing 51. A flange 52 holds a pressure sensor 206a′ on the axial side of ball bearing 51, and a synchronizing disk 53 from the other side presses pressure sensor 206a against the corresponding annular surface of ball bearing 51.

According to FIG. 5, another alternative lies in absorbing the pressure and tensile forces in foot support 40. In this context, the tensile and pressure forces that the patient exerts upon leg movement rail 10 are measured on the reverse side of foot plate 41 of leg movement rail 10. The foot of the patient is secured on foot plate 41 in such a way that both the pressure forces as well as the tensile forces are reliably transmitted to the sole pressure sensor 206b.

Sensor 206b is mounted gloatingly” on the reverse side of foot sole plate 41 between two pressure plates 56 and 57, which make it possible to mechanically attach foot sole plate 41 on foot support 40 or on extending pair of rods 15 of leg movement rail 10. From the measured value from sensor 206b the force direction (tension or pressure) can be determined and further processed by the control program. Sensor 206b is configured as a flat sensor. Both pressure plates 56 and 57 with pressure and tension sensor 206b arranged between them are connected to foot sole plate 41 via a countersunk bolt 58 and a wing nut 59, whereby on the side of exterior pressure plate 56, facing away from foot sole plate 41, an ankle clamp 61 is supported that is also connected to this pressure plate 56.

It was described above how the patient's exertion of force in the pressure or tension direction is measured by a sensor 206, 206′, 206a, 206a′, or 206b. According to an undepicted further embodiment, however, in order to avoid using sensors, the active exertion of force of the patient in one or another direction is measured via a current or rotational speed measurement and is supplied to measuring unit 216. In this way, the motor functions as a brake.

In accordance with a further embodiment, a combination of sensors and current-rotational speed measurement is provided.

The flowchart according to FIG. 6 shows the operation and the sequence program of leg movement rail 10. After the user has started leg movement rail 10 using the START key on remote control unit 300, the therapy session begins. At this point in time, parameters such as velocity, operating mode (active or passive), and range of motion (ROM) are defined by a preselection in remote control unit 300.

In step 410, the programmed therapy parameters are loaded by the program and in subprogram 420 are assigned to the internal variables, and the motor is started. In the active operating mode, a basic velocity is used that, depending on the patient activity, can increase up to the programmed maximum velocity. In the passive operating mode, the programmed maximum velocity is used.

In branch 440, it is ascertained whether the target position (ROM) of leg movement rail 10 has been reached. If it has, then in step 565 the motor is stopped, and the following branch 570 determines whether a pause should be inserted in step 580. After the expiration of the pause, the change in direction is undertaken in subprogram 590, and the velocity is once again set. In the active operating mode, the basic velocity is set, and in the passive operating mode the maximum programmed velocity is set [by] remote control unit 300. The program is continued from step 430.

As long as the target position in branch 440 has not yet been reached, in step 450 it is ascertained whether a preset therapy time has expired. If it has, then leg movement rail 10 is placed via step 550 in the central position, and the sequence program is terminated via step 560.

If no therapy time has been used or if it has not yet expired, then in branch 460, it is ascertained whether a STOP request has been made by the patient or by leg movement rail 10 (e.g., an error message). In this case, the immediate termination of the sequence program is carried out via step 560, and leg movement rail 10 is halted.

If the sequence program can be continued, then via branch 470 the distinction is made between the active and passive operating modes. In the active operating mode, in subprogram 480 the patient activity is measured. In accordance with the measured pressure or tension value, which the patient exerts on the leg movement rail, the velocity is either raised in step 500 up to the programmed maximum velocity or alternatively is lowered to the basic velocity in step 520. Otherwise, the velocity is maintained in step 520. In the passive operating mode, the patient activity is not taken into account, and the sequence program is continued from position 500.

In step 540, feedback information is directed to the patient, so that the latter may carry out the appropriate corrections. The sequence program is continued from position 430.

The sequence program in accordance with FIG. 7 depicts the sequence program of subprogram 420 (FIG. 6) for initializing the target position (ROM), the velocity, and the rotational direction of motor 204.

By calling up subprogram 420, in step 420.1, it is established that the first direction of motion must occur in stretching, from which is derived the rotational direction of motor 204. In step 420.3, the end of the ROM variable is initialized with the programmed stretching value of remote-control unit 300. As a function of the operating mode 420.5, in the active operating mode, in step 420.6 the velocity of the motor is set at a basic velocity. In the passive operating mode, in step 420.7 the velocity is set at the programmed maximum velocity from remote-control unit 300.

In step 420.8, motor 204 is started at the initialized rotational direction and velocity. Subprogram 420 is terminated.

The sequence program in accordance with FIG. 8 represents the program of subprogram 590 (FIG. 6) for the initialization of the subsequent target position ROM, velocity, and rotational direction of motor 204.

By calling up the subprogram, in step 590.1 the direction reverse is initialized. The target position, the end of the ROM, is selected in steps 590.3 and 590.4 as a function of the direction. This also determines the rotational direction of motor 204. Subsequently, the velocity of motor 204 is set as a function of the operating mode. In the active operating mode, the basic velocity is set in step 590.6. In the passive operating mode, the maximum program velocity from remote control unit 300 is set in step 590.7.

In step 590.8, the motor is started at the initialized rotational direction and velocity. Subprogram 590 is terminated.

1. A leg movement rail (10) for the repetitive movement of the knee and hip joint, comprising a base (20), a motor and transmission unit (204), a motor control unit (205) that is preferably attached to the base (20), a support system (12, 13) for the thigh that is fastened at one end to the base (20) by a rotary joint (31), a support system (14, 15) for the lower leg that is fastened on the base (20) by a joint that is movably arranged along the base (20), and a joint mechanism (27) connecting the other end of the support system (14, 15) for the lower leg and the support system (12, 13) for the thigh, wherein in addition to a preferably adjustable, continuously passive movement of the leg movement rail (10) by the motor and transmission unit (204), an active mobilization of the leg movement rail (10) by the patient, influencing said movement, can be brought about in that the pressure and/or tensile forces exerted by the patient are ascertained by sensors (206) and/or by a measurement of the current or rotational speed, the measurement value of said forces being supplied to the motor control unit (205) and conveyed as a control variable for the motor and transmission unit (204).

2. The leg movement rail as recited in claim 1, wherein for a control variable for the motor and transmission unit (204) that is greater than zero, a minimum force must be exerted by the patient.

3. The leg movement rail as recited in claim 1 or 2, wherein the magnitude of the pressure or tensile force applied by the patient is a measure for the velocity of the movement of the support system (14, 15) for the lower leg.

4. The leg movement rail as recited in at least one of the preceding claims, wherein the motor control unit (205) has a CPU (210), which drives a driver unit (214) for the drive motor of the motor and transmission unit (204) as a function of patient activity.

5. The leg movement rail as recited in claim 4, wherein the CPU (210) drives the driver unit (214) as a function of the angular position of the joint mechanism (27).

6. The leg movement rail as recited in claim 4 or 5, wherein the CPU (210) of the motor control unit (205) is connected to a CPU (301) of a control unit (300) that is preferably configured as a remote control unit.

7. The leg movement rail as recited in claim 6, wherein the control unit (300) has an input keypad (303), for programming the leg movement rail (10), and a display (30).

8. The leg movement rail as recited in at least one of claims 1 to 7, wherein the sensors (206) that measure the pressure forces or the tensile forces are arranged in a sliding carriage (21), which can be moved by means of a threaded spindle (22) of the motor and transmission unit (204) and which is connected to a connecting element (18) of the support system (14, 15) for the lower leg.

9. The leg movement rail as recited in claim 8, wherein the sensors (206) are flat sensors, which are arranged in the vicinity of an axial end of the sliding carriage (21).

10. The leg movement rail as recited in at least one of claims 1 to 7, wherein the sensors (206) that measure the pressure forces or the tensile forces are arranged in an end bearing block (24) of a threaded spindle (22) of the motor and transmission unit (204), the connecting element (18) of the support system (14, 15) for the lower leg being moved by means of said threaded spindle.

11. The leg movement rail as recited in claim 10, wherein the sensors (206) are ring sensors, which are arranged on both sides of a ball bearing (51) that surrounds the bearing end of the threaded spindle (22).

12. The leg movement rail as recited in at least one of claims 1 to 7, wherein the sensors (206) that measure the pressure forces or the tensile forces are arranged in a foot support (40) of the leg movement rail (10), which is supported at the end of an extending support (15) of the support system (14, 15) for the lower leg and which is provided with attachment points (42) for the patient's foot.

13. The leg movement rail as recited in claim 12, wherein a single pressure sensor (206) is configured as a flat sensor, which is floatingly supported between two pressure plates (56, 57) of the foot support (40), whereby the pressure plates (56, 57) make it possible to mechanically attach the foot support (40) to the support system (14, 15) for the lower leg.
